(19) United States
(12) Patent Application Publication
(10) Pub. No.: US 2019/0320595 A1
(43) Pub. Date: Oct. 24, 2019

(54) PROTECTIVE BARRIER FOR PLANT ROOTS

(71) Applicant: Ervin Issagholian, Sun Valley, CA (US)

(72) Inventor: Ervin Issagholian, Sun Valley, CA (US)

(21) Appl. No.: 16/389,527

(22) Filed: Apr. 19, 2019

Related U.S. Application Data
(60) Provisional application No. 62/660,437, filed on Apr. 20, 2018.

(51) Int. Cl. A01G 13/02; A01G 13/10

(52) U.S. Cl. CPC A01G 13/0237; A01G 13/10

(57) ABSTRACT

A root protective barrier includes a sidewall and a base. The sidewall includes a plurality of crisscrossing rods defining openings therebetween. The sidewall further includes an upper edge defining a top opening and a lower edge defining a bottom opening. The base includes a plurality of crisscrossing rods defining openings therebetween. The base further includes an upper surface, a lower surface, and an outer edge. The lower edge of the sidewall is coupled to the upper surface of the base so that the base covers the bottom opening. The root protective barrier is made of a polymer, such as a plastic, so that the root protective barrier does not degrade over time.

### CROSS-REFERENCE TO RELATED APPLICATION

This application claims the benefit of priority of U.S. provisional application No. 62/660,437, filed Apr. 20, 2018, the contents of which are herein incorporated by reference.

### BACKGROUND OF THE INVENTION

The present invention relates to protecting plant roots from rodents and varmints and, more particularly, to a protective barrier for plant roots.

Gophers and moles eat plant roots and plants, thereby destroying gardens. Currently, chicken wire or wire mesh may be used to protect the plants. Chicken wire is a metal wire and very difficult to handle. Metal wires also corrode and rust away underground. The plant needs protection during its entire lifetime, and wire meshes only provide protection for a few months. Once the metal wire corrodes and rusts away underground, the roots are exposed to gophers and moles.

As can be seen, there is a need for an improved protective barrier for plant roots.

### SUMMARY OF THE INVENTION

In one aspect of the present invention, a root protective barrier comprises: a sidewall comprising a plurality of crisscrossing rods defining openings therebetween, the sidewall further comprises an upper edge defining a top opening and a lower edge defining a bottom opening; and a base comprising a plurality of crisscrossing rods defining openings therebetween, the base further comprising an upper surface, a lower surface, and an outer edge, wherein the lower edge of the sidewall is coupled to the upper surface of the base so that the base covers the bottom opening, and the root protective barrier is made of a polymer.

In another aspect of the present invention, a method of planting a plant comprises: providing a root protective barrier comprising: a sidewall comprising a plurality of crisscrossing rods defining openings therebetween, the sidewall further comprises an upper edge defining a top opening and a lower edge defining a bottom opening; a base comprising a plurality of crisscrossing rods defining openings therebetween, the base further comprising an upper surface, a lower surface, and an outer edge, wherein the lower edge of the sidewall is coupled to the upper surface of the base so that the base covers the bottom opening, and the root protective barrier is made of a polymer; placing roots of the plant within the root protective barrier so that leaves of the plant extend above the top opening; and burying the root protective barrier in the earth.

These and other features, aspects and advantages of the present invention will become better understood with reference to the following drawings, description and claims.

### BRIEF DESCRIPTION OF THE DRAWINGS

FIG. 1 is an exploded view of an embodiment of the present invention, shown in use;

FIG. 2 is an exploded view of an embodiment of the present invention;

FIG. 3 is an exploded view of an embodiment of the present invention; and

FIG. 4 is a side view of an embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a protective barrier for plant roots against gophers and moles. The present invention creates a barrier around the plant roots so the gophers and moles cannot reach the root systems. The present invention is a protective barrier that may be made of plastic and includes openings so that the roots are allowed to grow through the barrier. The present invention is easy to handle and assemble and lasts a lifetime underground. The present invention does not corrode or rust underground.

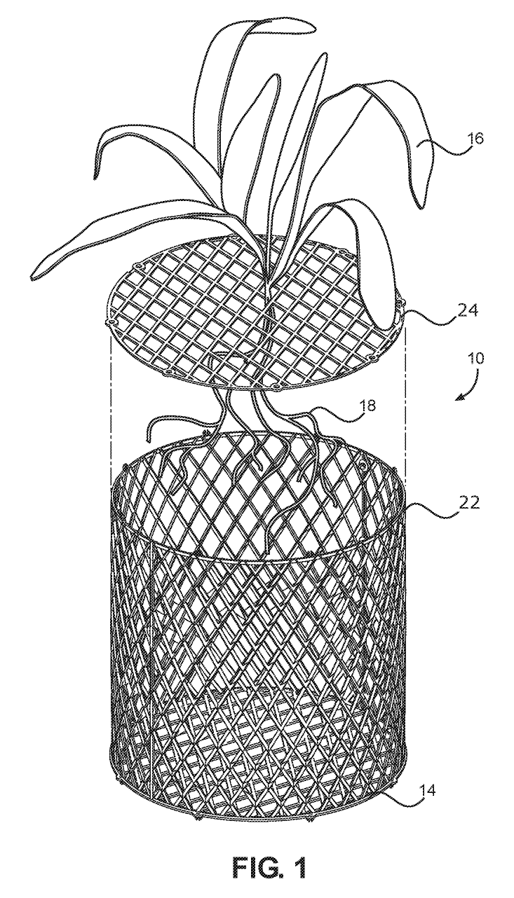

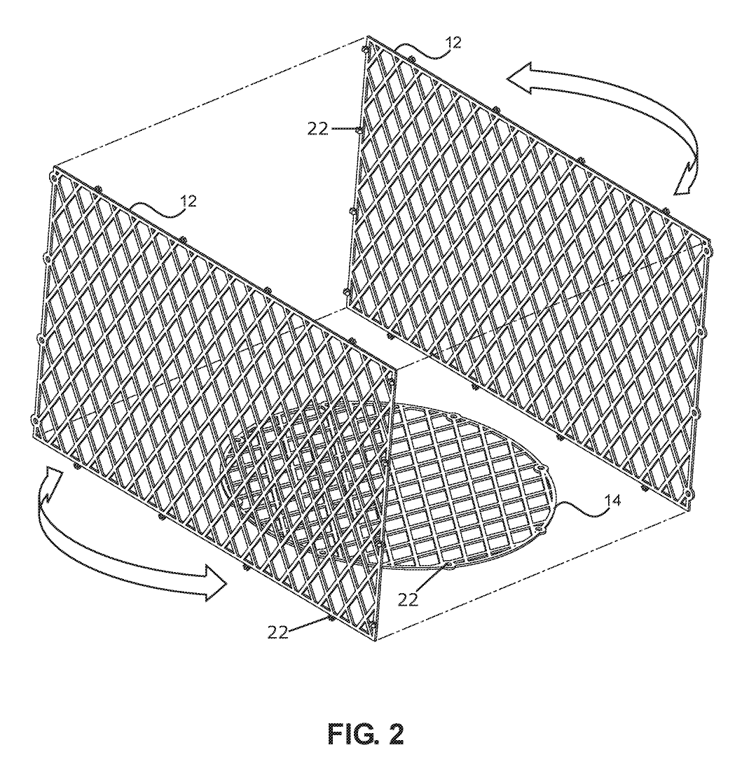

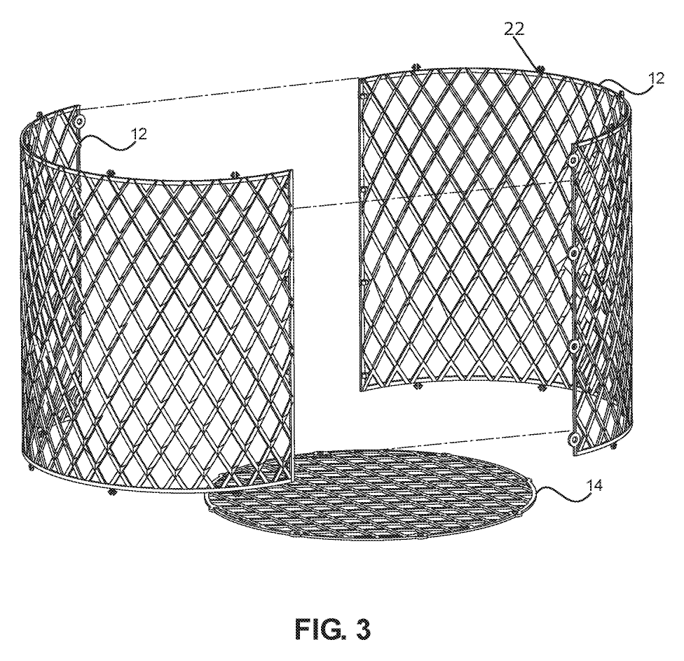

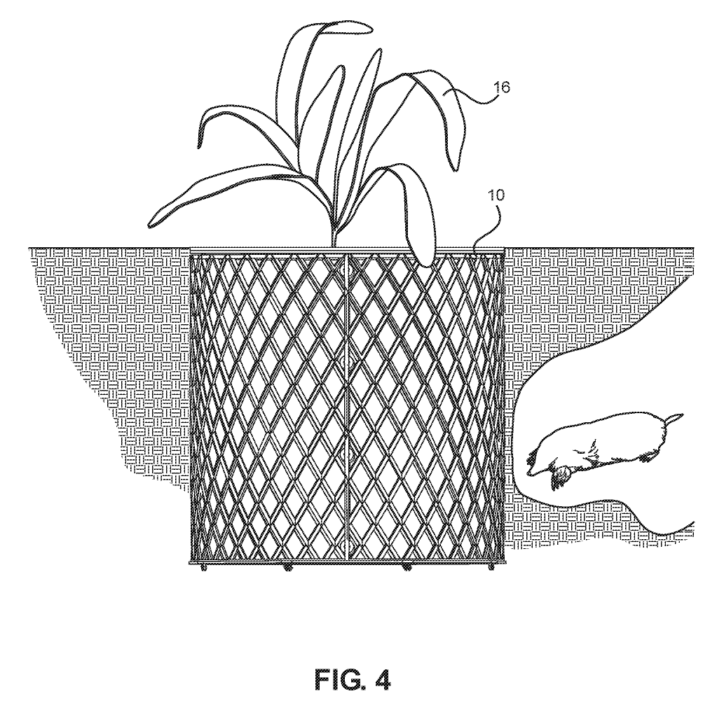

Referring to FIGS. 1 through 4, the present invention includes a root protective barrier 10. The root protective barrier 10 includes a sidewall 12 and a base 14. The sidewall 12 includes a plurality of crisscrossing rods defining openings therebetween. The sidewall 12 further includes an upper edge defining a top opening and a lower edge defining a bottom opening. The base 14 includes a plurality of crisscrossing rods defining openings therebetween. The base 14 further includes an upper surface, a lower surface, and an outer edge. The lower edge of the sidewall 12 is coupled to the upper surface of the base 14 so that the base 14 covers the bottom opening. The root protective barrier 10 is made of a polymer, such as a plastic, so that the root protective barrier 10 does not degrade over time.

In certain embodiments, the present invention includes fasteners 22 coupling the base 14 to the sidewall 12. The fasteners 22 may include openings and barbed snap clips sized to snap into the openings. For example, a plurality of openings may be disposed about the outer edge of the base 14. A plurality of barbed snap clips may be protruding downwards from the lower edge of the sidewall 12. The plurality of barbed snap clips fit within the plurality of openings and lock the base 14 to the sidewall. 12.

The base 14 may include a flat and circular or squared shape. The sidewall 12 may include a cylinder shape or a cuboid shape. The sidewall 12 is coupled to the outer edge of the base 14. In certain embodiments, the sidewall 12 may include a first half and a second half coupled together along a length of the cylinder shape by the fasteners 22. For example, a first side edge of the first half may include a plurality of openings, and a second side edge of the second half may include a plurality of barbed snap clips. The plurality of barbed snap clips fit within and the plurality of openings and lock the first half to the second half.

The present invention may further include a lid 24. The lid 24 includes a plurality of crisscrossing rods defining openings therebetween. The lid 24 further includes an upper surface, a lower surface, and an outer edge. The lower surface is coupled to the upper edge of the sidewall 12 so that the lid 24 covers the top opening.

A method of planting a plant includes the following: provide the root protective barrier 10 described above; place roots 18 of the plant 16 within the root protective barrier 10 so that leaves of the plant extend above the top opening; bury the root protective barrier in the earth; couple the lid 24 to the upper edge of the sidewall 12 so that the lid 24 covers the top opening; and run the leaves and stem of the plant 16 through one of the openings of the lid 24.

The present invention may be made of plastic injection molding or 3d printing. Each sized barrier may include two injection molds to complete. The size of the barrier 10 may vary and perform the same function. The shape of the openings can be diamond, square, circular, perforated or in any other form to allow the roots to grow out but to block the gophers or moles from entering. The entire piece can also be made as one piece without the need to assemble.

It should be understood, of course, that the foregoing relates to exemplary embodiments of the invention and that modifications may be made without departing from the spirit and scope of the invention as set forth in the following claims.

What is claimed is:

1. A root protective barrier comprising:
a sidewall comprising a plurality of crisscrossing rods defining openings therebetween, the sidewall further comprising an upper edge defining a top opening and a lower edge defining a bottom opening; and
a base comprising a plurality of crisscrossing rods defining openings therebetween, the base further comprising an upper surface, a lower surface, and an outer edge, wherein
the lower edge of the sidewall is coupled to the upper surface of the base so that the base covers the bottom opening, and
the root protective barrier is made of a polymer.

2. The root protective barrier of claim 1, wherein the base comprises a flat and circular shape, wherein the sidewall is coupled to the outer edge of the base.

3. The root protective barrier of claim 1, further comprising fasteners coupling the base to the sidewall.

4. The root protective barrier of claim 3, wherein the fasteners comprise openings and barbed snap clips sized to snap into the openings.

5. The root protective barrier of claim 4, wherein the sidewall comprises a cylinder shape.

6. The root protective barrier of claim 5, wherein the sidewall comprises a first half and a second half coupled together along a length of the cylinder shape by the fasteners.

7. The root protective barrier of claim 1, further comprising a lid comprising a plurality of crisscrossing rods defining openings therebetween, the lid further comprising an upper surface, a lower surface, and an outer edge, wherein the lower surface is coupled to the upper edge of the sidewall so that the lid covers the top opening.

8. A method of planting a plant comprising:
providing a root protective barrier comprising:
a sidewall comprising a plurality of crisscrossing rods defining openings therebetween, the sidewall further comprises an upper edge defining a top opening and a lower edge defining a bottom opening;
a base comprising a plurality of crisscrossing rods defining openings therebetween, the base further comprising an upper surface, a lower surface, and an outer edge, wherein
the lower edge of the sidewall is coupled to the upper surface of the base so that the base covers the bottom opening, and
the root protective barrier is made of a polymer;
placing roots of the plant within the root protective barrier so that leaves of the plant extend above the top opening; and
burying the root protective barrier in the earth.

9. The method of claim 8, wherein the root protective barrier further comprises a lid comprising a plurality of crisscrossing rods defining openings therebetween, the lid further comprising an upper surface, a lower surface, and an outer edge.

10. The method of claim 9, further comprising coupling the lid to the upper edge of the sidewall so that the lid covers the top opening and running the leaves and stem of the plant through one of the openings of the lid.
